(19) United States
(12) Patent Application Publication
(10) Pub. No.: US 2026/0169923 A1
(43) Pub. Date: Jun. 18, 2026

(54) DEVICE, METHOD AND SYSTEM TO PROVIDE OPERAND INFORMATION WITH A BYPASS CACHE AND A PHYSICAL REGISTER FILE

(71) Applicant: Intel Corporation, Santa Clara, CA (US)

(72) Inventors: Freddy Torres, Portland, OR (US); Roger Gramunt, Portland, OR (US); Brian Hickmann, Sherwood, OR (US); Alexey Suprun, Beaverton, OR (US); Michael Abbott, Brigham City, UT (US); Henry Wong, Hillsboro, OR (US); Bhavya Daya, Hillsboro, OR (US)

(73) Assignee: Intel Corporation, Santa Clara, CA (US)

(21) Appl. No.: 18/986,343

(22) Filed: Dec. 18, 2024

(51) Int. Cl. G06F 12/0888

(52) U.S. Cl. CPC G06F 12/0888

(57) ABSTRACT

Techniques and mechanisms for a cache structure to facilitate time-efficient (re)use of an operand value in the execution of a micro-operation (μop). In an embodiment, a processor comprises a physical register file (PRF), and a cache which is coupled between a writeback path and the PRF. The cache functions as a holding buffer that stores operand values recently provided via one or more ports of the processor. A given operand value is available to be accessed in the cache for use in executing a μop. The operand value is subject to being drained into the PRF, from which it can then be accessed for use in the μop execution. In another embodiment, a reservation station is configured to track a readiness state of the μop based on information which specifies that the cache is a currently a repository of the operand value.

### BACKGROUND

### 1. Technical Field

This disclosure generally relates to processor architectures and more particularly, but not exclusively, to a cache structure which is coupled to provide operand information to a physical register file of a processor.

### 2. Background Art

Processing device cores typically include, but are not limited to, a front-end pipeline (FEP) and an execution engine (EE). Generally, the FEP retrieves instructions from memory, decode the instructions, and buffer them for downstream stages. The EE then dynamically schedules and dispatch the decoded instructions to execution units for execution. Such an EE includes a variety of components, one of which is the scheduler. The scheduler is the EE component that queues micro-operations (μop) until all source operands of the μop are ready. In addition, the scheduler schedules and dispatches ready μops to available execution units of the EE.

To improve performance, some processors execute instructions in parallel. To execute different portions of a single program in parallel, a scheduler often schedules some instructions for execution out of their original order. Generally, μops wait at the scheduler until they are ready for execution. The process of waking up and scheduling a μop that is waiting for valid source data can be timing critical. As the depth of schedulers increases (e.g., for performance reasons), the number of μops waiting in a scheduler increases and, as a result, it tends to become more difficult to wake up and schedule a μop in a single cycle, or a limit may have to be placed on the number of μops that may wait for valid source data at the scheduler.

A reservation station (RS) usually provides a buffer to queue μops until all source operands are ready. The size of the RS is limited based on space and timing pressures of the architecture of the processing device.

As successive generations of processor architectures continue to increase in number, variety, and capability, there is expected to be an increasing premium placed on improvements to the provisioning of operand values for time efficient execution of μops.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a processor to provide operand values with a bypass cache according to an embodiment.

FIG. 2 shows a flow diagram illustrating features of a method to schedule μop execution based on an operand value at a bypass cache according to an embodiment.

FIG. 3 shows a block diagram illustrating features of a tracker unit to maintain operand location information according to an embodiment.

FIG. 4 shows a block diagram illustrating features of a processor to manage the allocation of μops for execution according to an embodiment.

FIG. 5 shows a block diagram illustrating features of a bypass cache unit to make operand values available according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

Embodiments discussed herein variously provide techniques and mechanisms for a cache structure to facilitate time-efficient (re)use of an operand value in the execution of a micro-operation (μop). The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which provides bypass cache functionality in support of a physical register file.

Modern superscalar, out-of-order processors utilize a physical register file (PRF) to store results from micro-operations (μops). An example of one such result is a value of an operand—e.g., wherein the value is determined by the execution of a given μop, and is to be used as an operand in the later execution of another μop.

As successive generations of processor architectures become wider (e.g., provide an increased number of execution units), the required number of read ports and/or write ports for a given PRF tends to increase. Similarly, as successive generations of processor architectures become deeper (e.g., capable of supporting a greater number of concurrent in-flight instructions), the required number of entries in a given PRF tends to increase. However, a large, highly multi-ported PRF tends to be cost-prohibitive at least in terms of area, power consumption and/or read latency.

To facilitate improved PRF functionality—e.g., by mitigating read bandwidth constraints and/or write bandwidth constraints of a PRF—some embodiments provide a structure (referred to herein as a “bypass cache”) which supports the provisioning of operand data. In an embodiment, a bypass cache is coupled between a PRF and a writeback path by which a value of an operand (“operand value” herein) is provided from an execution pipeline. The bypass cache operates as an at least temporary repository of one or more operand values that are available to be read, from said bypass cache, without requiring an access of the PRF.

In one such embodiment, operand data is first written to the bypass cache, which functions as a holding buffer that stores the last N operand values—e.g., where N is a positive integer greater than one (1)—from a given one or more ports including (for example) a writeback port of the processor. The bypass cache provides (or “drains”) some or all such buffered operand values to the PRF over time, whereupon said drained operand values are available to be read, additionally or alternatively, from the PRF. In various embodiments, operand values are drained from a bypass cache to a PRF according to a first-in, first-out (FIFO) scheme. In various embodiments, reservation station circuitry of a processor facilitates location tracking which supports the accessing of operand values in either of a bypass cache or a PRF.

In the context of an operand value in a bypass cache, “drain”, “drained”, “draining”, and related terms variously refer herein to the action of providing (e.g., moving or copying) the operand value to a PRF. Furthermore, “eviction”, “evicted”, and related terms variously refer herein to the action of ending an availability of the operand value in the bypass cache. Eviction of a given operand value from a bypass cache comprises, for example, overwriting the operand value in an entry of the bypass cache, or—alternatively—invalidating the operand value in said entry. It is to be noted that a draining of an operand value from a bypass cache, in and of itself, does not necessarily comprise evicting the operand value from the bypass cache—e.g., wherein the operand value is copied to the PRF, and—thereafter—is at least temporarily available from either one of the bypass cache an the PRF.

In providing such a bypass cache, as well as scheduling functionality which avails of the bypass cache, some embodiments variously enable a decoupling of one or more PRF read/write port constraints from operations of other processor circuitry. Such decoupling mitigates operational load on the PRF, and (for example) enables previously unavailable PRF (or other) design possibilities. In various embodiments, use of a bypass cache facilitates improved power efficiency by reducing the number of PRF reads.

As used herein, “source operand” refers to an operand of a μop or other suitable instruction, wherein the value of the μop is determined prior to the execution of said μop, and is to be a basis for said execution. For brevity, the term “operand”—on its own—is understood to refer herein to a source operand, unless otherwise indicated. As used herein, “operand value” refers herein to a determined value which is to be that of a respective source operand. The term “operand data” refers herein to one or more operand values.

Some embodiments variously maintain, evaluate or otherwise access information (referred to herein as “operand location information”) which specifies or otherwise indicates a locatability of a given operand value. As used herein in the context of an operand of a μop (or other suitable instruction), “available” “availability” and related terms variously refer to the condition of a value, for the operand in question, having been determined, and a location of the operand value having been identified—e.g., to a relevant processor resource such as a tracker unit or other suitable circuitry.

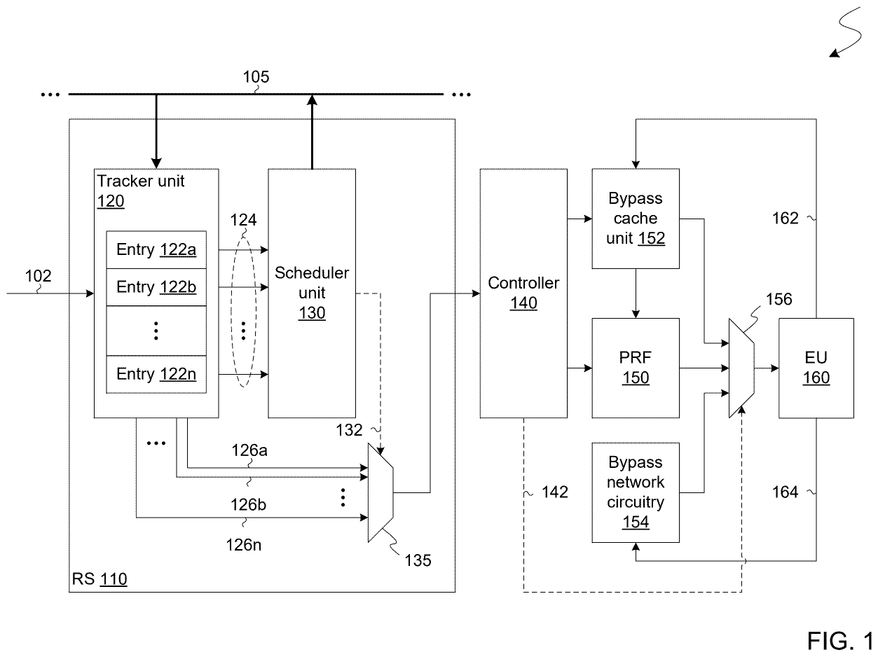

FIG. 1 shows a processor 100 which provides operand values with a bypass cache according to an embodiment. The processor 100 illustrates features of one example embodiment wherein a cache (referred to herein as a “bypass cache”) is coupled to receive and store operand values before some or all such operand values are variously drained to a physical register file (PRF).

As shown in FIG. 1, processor 100 comprises an execution unit (EU) 160 and a reservation station (RS) 110 which facilitates the scheduling of one or more micro-operations (μops) to be variously executed with EU 160. Processor 100 is adapted, for example, from any of various suitable single-core or multi-core processors which support the scheduling of a μop, wherein a PRF is available to provide the value of an operand of said μop.

In the example embodiment shown, RS 110 is coupled to receive a sequence 102 of micro-operations (μops) that, for example, are generated by a front-end (not shown) of processor 100. In one such embodiment, the front-end unit fetches instructions from an instruction cache, memory, or other suitable repository. The fetched instructions are passed to an instruction decoder, which disassembles instructions into primitives—e.g., micro-operations (μops) or other such dissembled instructions—for execution. The front-end unit is implemented in any suitable manner. In various embodiments, sequence 102 is provided to RS 110 via a rename/allocation unit (not shown) of processor 100. Some embodiments are not limited with respect to how sequence 102 is provided to RS 110.

RS 110 comprises circuitry to schedule the execution of various ones of the μops of sequence 102. RS 110 is implemented in any suitable portion of processor 100. In one embodiment, RS 110 is implemented in an out-of-order execution engine of processor 100. For example, such an out-of-order engine comprises any of various suitable additional components to reorder instructions in an out-of-order manner and to allocate resources for execution. In one such embodiment, the out-of-order engine renames logical resources and maps them to physical resources. RS 110 issues decoded instructions to one or more execution units comprising EU 160.

Execution unit 160 executes instructions (e.g., μops) that are received from RS 110, and signals when some or all such executed instructions are to be retired. Such retirement follows rules to ensure that data-dependency errors resulting from out-of-order execution are prevented. When instructions have executed, and are retired or committed, the results are written to a cache, a system memory, or any other suitable location (not shown). In one example embodiment, EU 160 comprises one or more arithmetic logic units (ALUs) to perform any of various arithmetic calculation instructions. Alternatively or in addition, EU 160 comprises one or more load pipelines, one or more store pipelines, and/or the like.

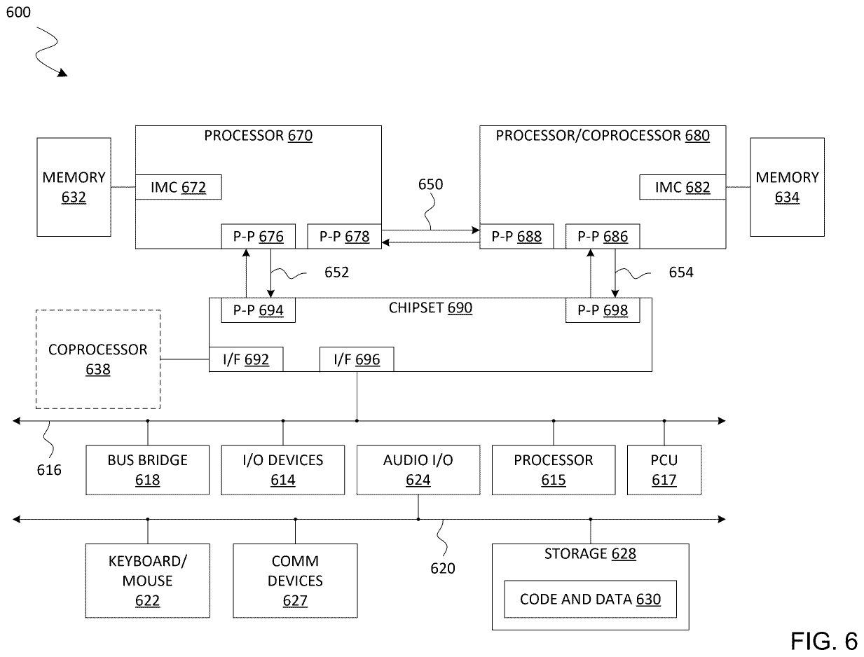

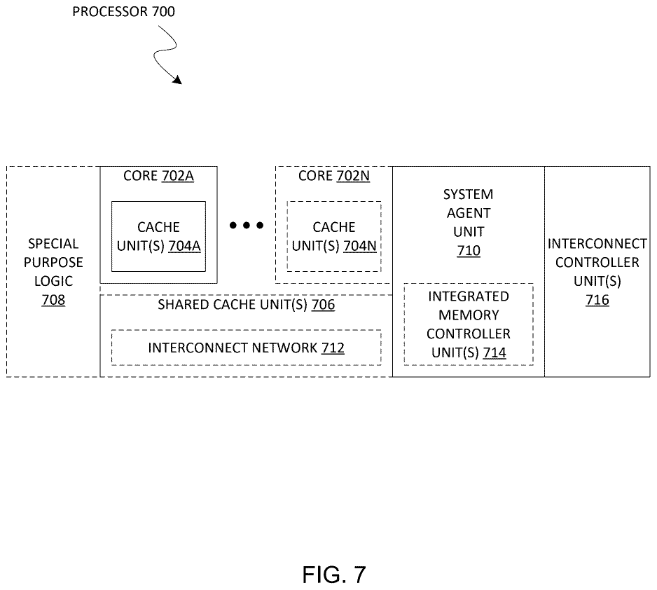

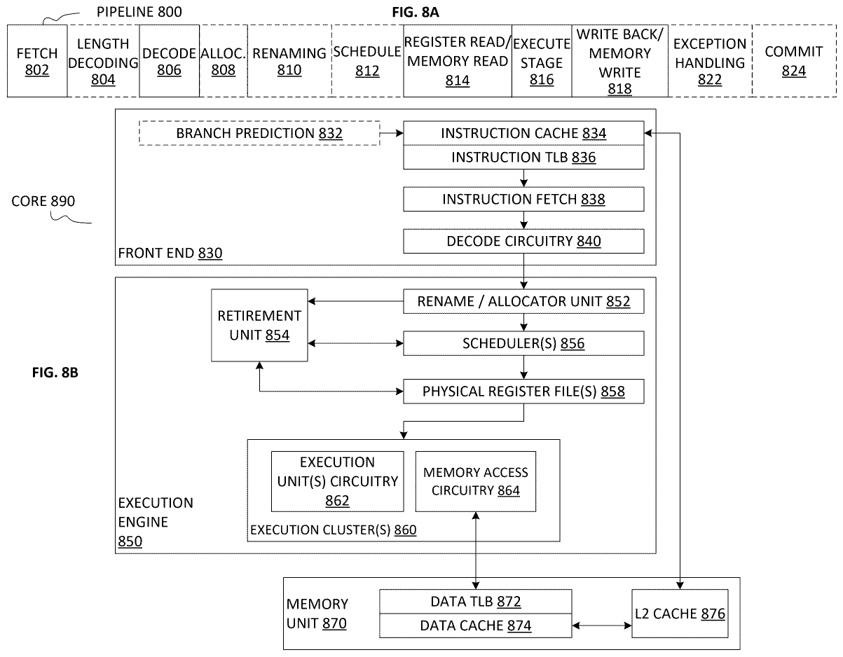

In some embodiments, circuitry of processor 100 is adapted from, and/or is incorporated with, any of various suitable processor architectures. By way of illustration and not limitation, any of various suitable embodiments of processor 100 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

Processor 100 comprises a physical register file (PRF) 150 which is coupled to store results from the execution of one or more μops by EU 160. For example, operand data generated by EU 160 is provided, directly or indirectly, to a writeback path 162—e.g., wherein the operand data includes one or more operand values each for a respective μop that is subject to being subsequently executed with EU 160 or other suitable execution circuitry of processor 100. Registers of PRF 150 are available to store operand values that, for example, are subject to being (re)used by EU 160 in the later execution of one or more other μops. By way of illustration and not limitation, a selector circuit 156 of processor 100 is coupled to selectively enable a given operand value to be communicated from PRF 150 to EU 160.

To mitigate an operational load on PRF 150, processor 100 further comprises a bypass cache unit 152 which is coupled between PRF 150 and the writeback path 162 by which operand values are provided from EU 160. In an embodiment, bypass cache unit 152 provides functionality of a repository for one or more operand values, which are available to be read from bypass cache unit 152 without requiring an access of PRF 150.

In one such embodiment, operand data is written to bypass cache unit 152, which functions as a holding buffer that stores the N operand values—e.g., where N is a positive integer greater than one (1)—most recently communicated from a given one or more ports including (for example) a writeback port which is at (or coupled to) EU 160. During operation of processor 100, bypass cache unit 152 successively receives operand values for caching, and successively drains respective ones of said operand values to PRF 150 over time, whereupon said drained operand values are available to be read, additionally or alternatively, from PRF 150. For example, operand values are drained from bypass cache unit 152 to PRF 150 according to a FIFO scheme.

In some embodiments, RS 110 facilitates location tracking mechanisms which support the provisioning of a given operand value in either of bypass cache unit 152 or PRF 150. In one such embodiment, RS 110 includes, is coupled to, or otherwise operates based on circuitry (such as that of the illustrative tracker unit 120 shown) which tracks state—referred to herein as “readiness state”—of one or more μops which await scheduling for execution. Tracking the current readiness state—e.g., one of a ready state or an unready state—of a given μop comprises tracker unit 120 maintaining information (referred to herein as “operand location information”) which specifies or otherwise indicates, for a given operand of an μop which awaits scheduling, whether a value of the operand has been determined to be available at a particular processor resource. For a given available operand value, corresponding operand location information specifies or otherwise indicates (for example) a particular processor resource—and, in some embodiments, a particular location in said processor resource—where the operand value in question is available to be accessed.

By way of illustration and not limitation, tracker unit 120 provides one or more sets of information (illustrated as entries 122 herein) which each correspond to a respective pending μop—i.e., a μop which awaits scheduling for execution. In the example embodiment shown, tracker unit 120 comprises entries 122a, 122b, . . . , 122n, although more, fewer and/or different entries are provided at tracker unit 120 in other embodiments. In an embodiment, a given one of entries 122 is to receive or otherwise determine readiness state information for the μop to which that entry corresponds. Such readiness state information includes, for example, respective operand location information for each of one or more source operands of the μop in question.

In the example embodiment shown, tracker unit 120 is coupled to receive a message (referred to herein as a “wakeup message”) which comprises operand location information that is to be provided to one of entries 122. For example, a wakeup message is received by tracker unit 120 via a bus 105—e.g., where the wakeup message is provided by EU 160, by bypass cache unit 152 or other circuit logic which is suitable to detect an (actual or expected) receipt of an operand value at a processor resource. In some embodiments, the wakeup message is provided to tracker unit 120 by scheduler unit 130—e.g., wherein scheduler 130 includes or otherwise has access to counter circuitry or other suitable logic (not shown) for deterministically identifying an entry in bypass network circuitry 154 which has received, or will receive, the operand value in question.

In an embodiment, such a wakeup message is generated based on a provisioning of an operand value to one of multiple processor resources including (for example) bypass cache unit 152 and PRF 150. In one such embodiment, the multiple processor resources further comprise a bypass network circuitry 154 of processor 100. Based on the provisioning of operand location information via bus 105, tracker unit 120 maintains up-to-date readiness state information in one or more of entries 122.

Based on the readiness state information maintained in various ones of entries 122, tracker unit 120 generates one or more ready signals 124 which each corresponds to a different respective pending μop. For a given one such μop, the corresponding ready signal 124 identifies whether the μop in question is ready to be allocated for future execution. In an illustrative scenario according to one embodiment, determining that a given μop is in a ready state comprises determining that, for each source operand (if any) of said μop, respective location information for that source operand indicates that the value of the source operand has been determined, and a particular location of the value has been identified to tracker unit 120.

In an embodiment, RS 110 includes, is coupled to, or otherwise operates based on scheduler unit 130 which schedules the execution of μops by EU 160. In one such embodiment, scheduler unit 130 selectively allocates a given ready μop for execution—e.g., wherein scheduler unit 130 operates one or more multiplexers and/or other suitable circuitry to select operand location information corresponding to the μop being allocated.

By way of illustration and not limitation, scheduler unit 130 is coupled to receive ready signals 124 from tracker unit 120 and to identify, based thereon, those ready μops (if any) which have been identified as being selectable for allocation to be executed. Based on the respective readiness states variously indicated by ready signals 124, scheduler unit 130 generates a control signal 132 which operates a selector circuit 135 to select operand location information which corresponds to the μop to be allocated. In an illustrative scenario according to one embodiment, selector circuit 135 is operated by control signal 132 to select operand location information 126a for a first μop which is tracked with entry 122a, or operand location information 126b for a second μop which is tracked with entry 122b, or operand location information 126n for a third μop which is tracked with entry 122n.

In one such embodiment, a controller 140 of processor 100 is coupled to receive the selected operand location information from selector circuit 135. Circuity of controller 140 provides functionality to control the accessing of a given operand value at a location which is indicated by the corresponding operand location information—e.g., information which is provided to controller 140 via selector circuit 135. For example, controller 140 provides functionality to operate either or each of bypass cache unit 152 and PRF 150, based on operand location information received from selector circuit 135, to make one or more operand values available for selection by a selector circuit 156 which is coupled between EU 160 and each of bypass cache unit 152 and PRF 150.

In the example embodiment shown, selector circuit 156 is coupled to receive respective outputs (e.g., including one or more operand values) from PRF 150, bypass cache unit 152 and—in some embodiments—bypass network circuitry 154. Selector circuit 156 provides functionality to select one such output for communication to EU 160—e.g., responsive to a control signal 142 from controller 140. In an illustrative scenario according to one embodiment, a first operand value is available, at a given time, to be selected with selector circuit 156 for communication from bypass cache unit 152 to EU 160. However, at a later time—e.g., after the first operand value has been drained from bypass cache unit 152 to PRF 150—that same first operand value is available to be selected selector with circuit 156 for communication from PRF 150 to EU 160. In some embodiments, an at least temporary accessibility of the first operand value at bypass cache unit 152 mitigates an operational load on PRF 150—e.g., where a likelihood of a given operand value being (re)used tends to decrease over time after said operand value is initially made available.

Although some embodiments are not limited in this regard, processor 100 further comprises bypass network circuitry 154 which is coupled to EU 160 via another writeback path 164. For example, bypass network circuitry 154 is coupled to receive another operand value from EU 160 via writeback path 164—e.g., wherein said operand value is expected to be reused relatively soon by EU 160. In an embodiment, writeback path 164 comprises a network of latch circuits which are coupled to forward the received operand value to selector circuit 156—e.g., in a predetermined number of cycles. In an embodiment, selector circuit 156 is operated to select any of multiple resources for providing a respective operand value to EU 160—e.g., wherein the multiple resources comprise PRF 150 and, in some embodiments, bypass network circuitry 154. In one such embodiment, tracker unit 120 facilitates the tracking of operand location information which identifies whether a given operand value is currently in bypass network circuitry 154. In some alternative embodiments, processor 100 omits bypass network circuitry 154 and writeback path 164.

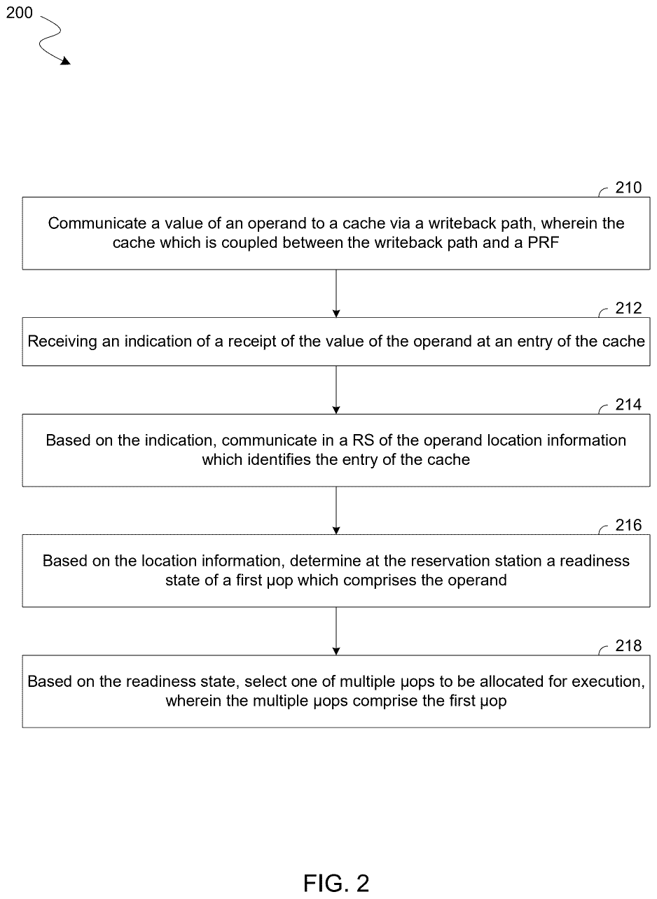

FIG. 2 shows a method 200 for scheduling μop execution based on an operand value at a bypass cache according to an embodiment. Method 200 illustrates one example of an embodiment wherein the receipt of an operand value at a bypass cache is indicated by operand location information which is to be a basis for μop scheduling. Operations such as those of method 200 are performed with any of various combinations of suitable hardware (e.g., circuitry), firmware and/or executing software which, for example, provide some or all of the functionality of processor 100.

As shown in FIG. 2, method 200 comprises (at 210) communicating a value of an operand to a cache via the writeback path, wherein the cache which is coupled between the writeback path and a PRF. For example, the value is generated with an execution pipeline by the executing of some earlier μop—e.g., wherein the execution pipeline, the writeback path, the cache, and the PRF comprise (respectively) EU 160, writeback path 162, bypass cache unit 152, and PRF 150.

Method 200 further comprises (at 212) receiving an indication of a receipt of the value of the operand at an entry of the cache. For example, the receiving is at tracker unit 120 of RS 110 based on the communication of a wakeup message via bus 105. Based on the indication which is received at 212, method 200 (at 214) communicates—in a reservation station (RS) of a processor with which method 200 is performed—operand location information which identifies the entry of the cache. In one such embodiment, the operand location information is communicated to a particular one of entries 122 which has been designated (or is being designated) to track a readiness state of a μop which includes the operand.

Based on the location information communicated at 214, method 200 (at 216) determines at the RS a readiness state of a first μop, wherein that first uop comprises the operand. In an embodiment, the determining at 216 comprises μop tracker circuitry of the RS identifying that, for each source operand of the μop, respective location information identifies a respective one of multiple candidate resources as a current repository of a value of the source operand. In this particular context, “candidate resource” refers to a resource which the tracker circuitry of the RS is capable of recognizing as a possible operand value repository. In an embodiment, the multiple candidate resources comprise the cache and the PRF (and in some embodiments, a bypass network, for example)—e.g., wherein tracker unit 120 is capable of recognizing either of bypass cache unit 152 and PRF 150 as being a current repository of a given operand value.

Based on the readiness state which is determined at 216, method 200 (at 218) selects one of multiple μops to be allocated, wherein the multiple μops comprise the first μop. For example, the selecting at 218 comprises selecting operand location information to be communicated to controller 140 (or other suitable circuitry of the processor), wherein the selected operand location information corresponds to the μop being allocated. In some embodiments, method 200 omits, but is performed based on, the communicating at 210—e.g., wherein method 200 is performed at circuitry of RS 110. Alternatively or in addition, the communicating at 210 is performed after one or more other operations of method 200, in some embodiments—e.g., wherein the indication received at 212 comprises the operand location information communicated at 214, which is deterministically identified before the entry receives the value of the operand.

In some scenarios, method 200 further detects that the value of the operand has been drained (e.g., moved or copied) from the cache to the PRF. For example, such movement to the PRF takes place before the first μop is selected to be allocated for future execution. In one such scenario, based on said movement, method 200 further updates the location information at the RS to identify the PRF as a current repository of the value. Although such an update to the location information does not, in and of itself, change the readiness state of the first μop, it does change the location information which is eventually to be used to locate the value of the operand after the first μop is allocated.

In various embodiments, detecting a movement (if any) of the value from the cache to the PRF comprises the RS initializing a counter variable which corresponds to the operand, wherein said initializing is based on the indication received at 212. The counter variable is then regularly updated—e.g., once per one or more cycles of the processor—according to an expected rate at which entries of the cache are drained to the PRF. In one such embodiment, operand tracker circuitry of the RS performs an evaluation to detect for a condition wherein the counter variable satisfies a test condition. For example, the test condition is based on a threshold count value which corresponds to a maximum expected duration of a given operand value in the cache.

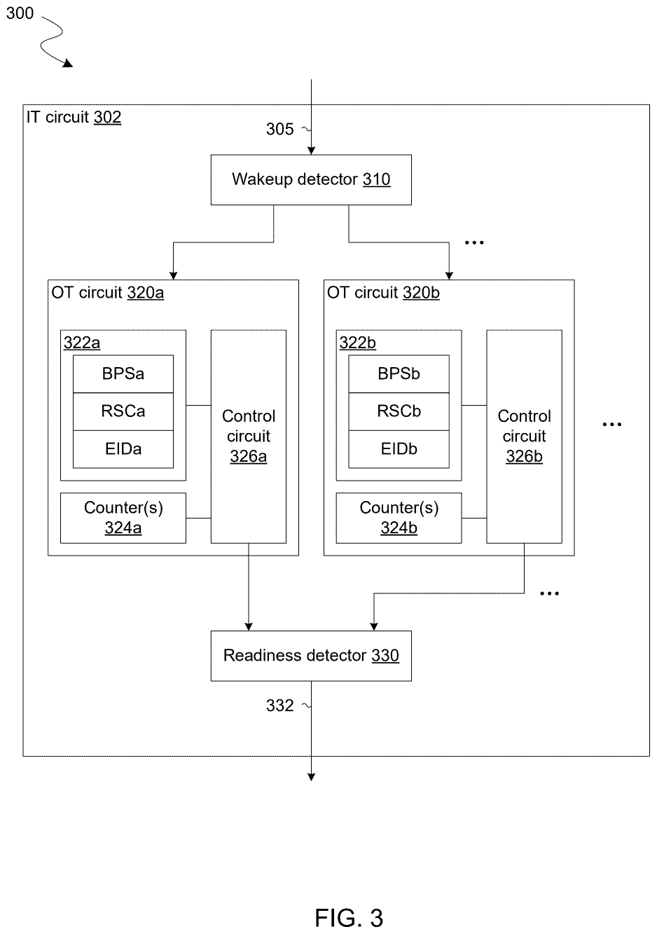

FIG. 3 shows a tracker unit 300 which maintains operand location information according to an embodiment. Tracker unit 300 illustrates features of one example embodiment which maintains readiness state information for one or more μops that await scheduling. In some embodiments, tracker unit 300 provides functionality such as that of tracker unit 120—e.g., wherein operations of method 200 are performed with some or all of tracker unit 300.

In various embodiments, tracker unit 300 comprises instruction tracker (IT) circuits which are each available to be designated as corresponding to a different respective μop which awaits scheduling for execution. Such IT circuits are each to provide a respective entry (e.g., one of the entries 122 of tracker unit 120) which includes readiness information for the corresponding pending μop. In an embodiment, such readiness information includes respective operand location information for each of one or more source operand (if any) of the corresponding μop. based on such readiness information, a given IT circuit generates a signal to identify the corresponding μop as being ready to be allocated.

As shown in FIG. 3, one such IT circuit 302 of tracker unit 300 comprises a wakeup detector 310 which is to receive operand location information 305—e.g., wherein operand location information 305 is provided to tracker unit 300 in a wakeup message such as one communicated via bus 105. IT circuit 302 further comprises one or more operand tracker (OT) circuits 320 some or all of which, while IT circuit 302 is designated to track state of a given μop, are each to correspond to a different respective source operand (if any) of that given μop.

By way of illustration and not limitation, an OT circuit 320a of IT circuit 302 is to maintain (and, for example, evaluate) respective location information for a first operand of the μop—e.g., wherein another OT circuit 320b of IT circuit 302 is to maintain and evaluate respective location information for a second operand of the μop.

In an embodiment, wakeup detector 310 provides functionality to detect that some or all of operand location information 305 corresponds to a particular operand of the μop that is currently being tracked by IT circuit 302. Based on such detection, wakeup detector 310 directs operand location information 305 (or a portion thereof) to a corresponding one of OT circuits 320.

By way of illustration and not limitation, OT circuit 320a comprises a repository 322a which receives from wakeup detector 310 a resource identifier parameter RSCa which identifies a particular one of multiple processor resources at which a first operand value is available (e.g., the multiple processor resources including a bypass cache, a PRF, and, in some embodiments, a bypass network). Alternatively or in addition, repository 322a receives from wakeup detector 310 an entry identifier parameter EIDa which identifies a particular entry—e.g., of a bypass cache or a PRF—at which the first operand value is available. Although some embodiments are not limited in this regard, repository 322a further receives from wakeup detector 310 a bypass select parameter BPSa which identifies a particular execution pipeline resource (e.g., a particular execution unit) which calculated or otherwise generated the first operand value. In various embodiments, repository 322a is operable to receive any of various additional or alternative information which identifies a locatability (if any) of the corresponding first operand value.

In some embodiments, prior to a receipt of corresponding location information, one or more parameters at repository 322a are each set to a respective value which specifies or otherwise indicates that the first operand value has yet to be made available. Alternatively or in addition, one or more of the parameters at repository 322a are updated (and in some embodiments, generated) at tracker unit 300—e.g., wherein control circuit 326a (or other suitable circuitry) of OT circuit 320a deterministically calculates a particular resource, and location in said resource, based on one or more counters 324a.

In one such embodiment, OT circuit 320b similarly comprises a repository 322a which receives from wakeup detector 310 a resource identifier parameter RSCb which identifies which of the multiple processor resources is able to provide a second operand value of the μop which is being tracked with IT circuit 302. Alternatively or in addition, repository 322b receives an entry identifier parameter EIDb which identifies a particular bypass cache entry (or PRF entry) at which the second operand value is available. Although some embodiments are not limited in this regard, repository 322b further receives a bypass select parameter BPSb identifying a particular execution pipeline resource which calculated or otherwise generated the second operand value.

In some embodiments, circuitry of tracker unit 300 is adapted from, and/or is incorporated with, any of various suitable processor architectures. By way of illustration and not limitation, any of various suitable embodiments of tracker unit 300 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In an embodiment, IT circuit 302 includes, is coupled to access, or otherwise operates with, circuitry (such as that of the illustrative readiness detector 330 shown) which detects, based on location information at one or more OT circuits 320 of IT circuit 302, whether the μop which is currently being tracked with IT circuit 302 is ready to be allocated. In an embodiment, detecting a readiness state of the μop comprises readiness detector 330 determining, for each source operand (if any) which is being tracked with the OT circuits 320 of IT circuit 302, that the value of the source operand has been identified as being available at a respective one of the multiple processor resources comprising the bypass cache and the PRF. By way of illustration and not limitation, OT circuits 320a, 320b comprise respective control circuits 326a, 326b which are operable to indicate that the first operand value and the second operand value are available to be communicated to an execution pipeline. Based on such indications from control circuits 326a, 326b, detector 330 generates a signal 322 (corresponding functionally to one of ready signals 124, for example) to indicate to a scheduler that location information in repositories 322a, 322b is ready to be used for accessing the first operand value and the second operand value each at a respective one of the multiple processor resources.

In some embodiments, operand location information for a given μop further comprises one or more counter variables, where each such counter variable is to be updated occasionally, and is to be made available as a basis for a respective evaluation to determine whether the operand location information is to be updated. By way of illustration and not limitation, OT circuit 320a comprises one or more counters 324a which are to be maintained and evaluated—e.g., by 326a—to facilitate a determining as to whether location information at repository 322a is to be updated to indicate a chance to a location of the available first operand value. Alternatively or in addition, OT circuit 320b comprises one or more counters 324b which are to be maintained and evaluated—e.g., by 326b—to facilitate a determining as to whether location information at repository 322b is to be updated to indicate a chance to a location of the available second operand value.

In an illustrative scenario according to one embodiment, counter(s) 324a comprise an operand-specific counter (referred to herein as a “bypass cache counter”) which is initialized (e.g., by control circuit 326a) when the first operand value is determined at IT circuit 302 to be available in a bypass cache. In an embodiment, the bypass cache counter is updated—e.g., regularly at an interval of one or more cycles—to account for a regular change to a location of the first operand value in a bypass cache (e.g., in bypass cache unit 152), relative to a location of a next operand value to be drained from the bypass cache. At some point during the maintaining of counter(s) 324a, control circuit 326a (or other suitable circuitry of tracker unit 300) performs an evaluation to determine, based on the operand-specific bypass cache counter, whether the first operand value in question has been drained from the bypass cache unit to a PRF. For example, control circuit 326a performs an evaluation to detect whether the bypass cache counter violates a respective test condition. In one such embodiment, the evaluation compares the bypass cache counter to a corresponding threshold count value which, for example, indicates or otherwise corresponds to a maximum possible duration of the first operand value in the bypass cache. Where such an evaluation determines that the first operand value has been drained, location information at repository 322a (e.g., including one or both of the parameters RSCa, EIDa) is updated—e.g., by control circuit 326a—to indicate that the first operand value is now in the PRF, rather than the bypass cache unit.

Alternatively or in addition, counter(s) 324a comprise an operand-specific counter (referred to herein as a “bypass network counter”) which is initialized (e.g., by control circuit 326a) when the first operand value is instead determined at IT circuit 302 to be available in a bypass network (e.g., in bypass network circuitry 154). In an embodiment, the bypass network counter is updated—e.g., regularly at an interval of one or more cycles—to account for a movement of the first operand value through the bypass network and, for example, a maximum possible duration of an operand value in the bypass network. At some point during the maintaining of counter(s) 324a, control circuit 326a performs an evaluation to determine, based on the operand-specific bypass network counter, whether the first operand value in question is no longer in the bypass network (and, for example, has been latched from the bypass network to an execution unit). For example, control circuit 326a performs an evaluation to detect whether the bypass network counter violates a respective test condition. In one such embodiment, the evaluation compares the bypass network counter to a corresponding threshold count value which, for example, indicates or otherwise corresponds to a maximum possible duration of the first operand value in the bypass network. Where such an evaluation determines that the first operand value is no longer in the bypass network, location information at repository 322a (e.g., including one or both of the parameters RSCa, EIDa) is updated—e.g., by control circuit 326a—to indicate that the first operand value is no longer available.

In some embodiments, one or more counters 324b of OT circuit 320b similarly include (for example) a bypass cache counter which is specific to a second operand value of the μop which is currently being tracked with IT circuit 302. Alternatively or in addition, counter(s) 324b similarly comprise a bypass network counter which is specific to the second operand value.

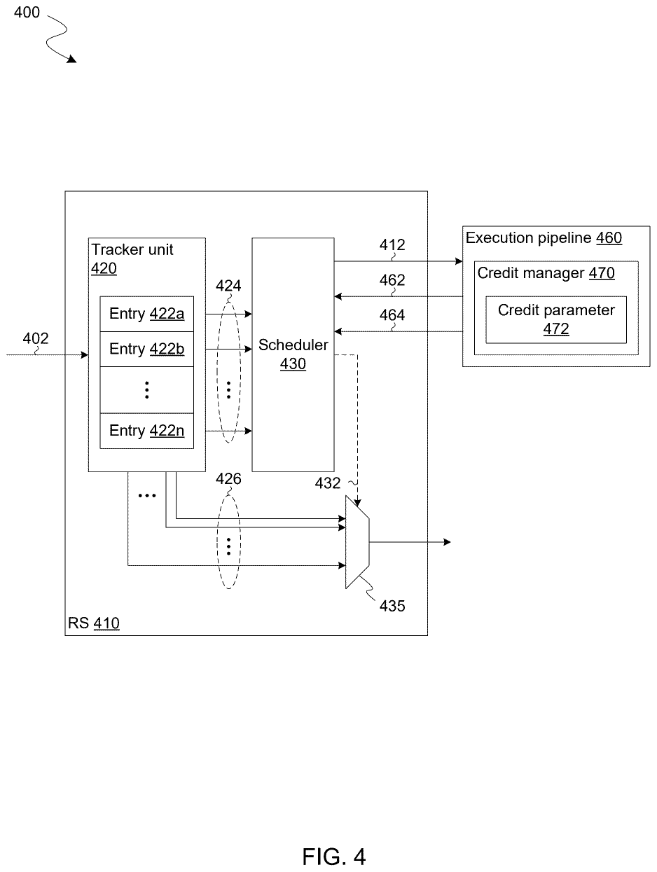

FIG. 4 shows a processor 400 which manages the allocation of μops for execution according to an embodiment. Processor 400 illustrates features of one example embodiment wherein a credit-based system is used to manage the scheduling of μop execution. In some embodiments, processor 400 provides functionality such as that of processor 100—e.g., wherein operations of method 200 are performed with some or all of processor 400.

As shown in FIG. 4, processor 400 comprises a reservation station (RS) 410 and an execution pipeline 460 which, for example, correspond functionally to RS 110 and EU 160 (respectively). The RS 410 comprises a tracker unit 420, a scheduler 430 and a selector circuit 435 which, in some embodiments, provide functionality of tracker unit 120, scheduler unit 130, and selector circuit 135 (respectively).

In some embodiments, circuitry of processor 400 is adapted from, and/or is incorporated with, any of various suitable processor architectures. By way of illustration and not limitation, any of various suitable embodiments of processor 400 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In the example embodiment shown, tracker unit 420 comprises multiple entries 422, some or all of which are available at a given time to be variously designated each to track readiness state information for a different respective μop of a μop sequence 402 (such as sequence 102) which is provided to RS 410. For example, tracker unit 420 includes some or all of the features of tracker unit 300, in one embodiment. For a given one of the illustrative entries 422a, 422b, . . . , 422n shown, readiness state information at the entry comprises location information for one or more source operands (if any) of the μop which is being tracked with said entry. Based on such operand location information, some or all of entries 422a, 422b, . . . , 422n each provide a respective one of ready signals 424 which each indicate whether a corresponding μop is ready to be allocated. Based on the readiness states variously indicated by ready signals 424, scheduler 430 operates selector circuit 435, with a control signal 432, to select from various instances 426 of operand location information each for a different respective μop. In an embodiment, the selected operand location information is communicated from selector circuit 435 to a controller or other suitable circuitry (not shown) which facilitates the accessing of one or more operand values each at a respective resource indicated by the selected operand location information.

Scheduler 430 is at risk of stalling (or otherwise interrupting the scheduling of μop executions) in the event of a condition wherein a bypass cache—e.g., at bypass cache unit 152—is at full occupancy, and no entries of the bypass cache are currently available. To mitigate this risk, some embodiments manage bypass cache occupancy using a credit-based scheme between RS 410 and execution pipeline 460. By way of illustration and not limitation, execution pipeline 460 includes, is coupled to, or otherwise operates with circuitry (such as that of the illustrative credit manager 470 shown) which participates in a credit management protocol whereby scheduler 430 is provided allocation credits, and variously signals that allocation credits are needed to facilitate μop allocations.

In the example embodiment shown, credit manager 470 maintains a credit parameter 472, the value of which is equal to—or otherwise based on—a current number of unused entries of the bypass cache in question. For example, the value of credit parameter 472 is increased when more bypass cache entries are available, and is decreased when relatively few bypass cache entries are available. The credit parameter 472 indicates a number of credits which are available to be provided to scheduler 430—e.g., where a given one such credit enables scheduler 430 to allocate one μop to be executed with execution pipeline 460.

By way of illustration and not limitation, scheduler 430 provides to credit manager 470 a signal 412 which indicates that an entry of the bypass cache is needed to facilitate the allocation of a μop. Responsive to signal 412, credit manager 470 sends back to scheduler 430 another signal 462 to indicate a total number of one or more bypass cache entries (if any) which have been drained to the PRF in a most recent one or more cycles. In one such embodiment, credit manager 470 further communicates to signal 464 a signal 464 which indicates to scheduler 430 a validity of one or more returned credits—e.g., as indicated by signal 462.

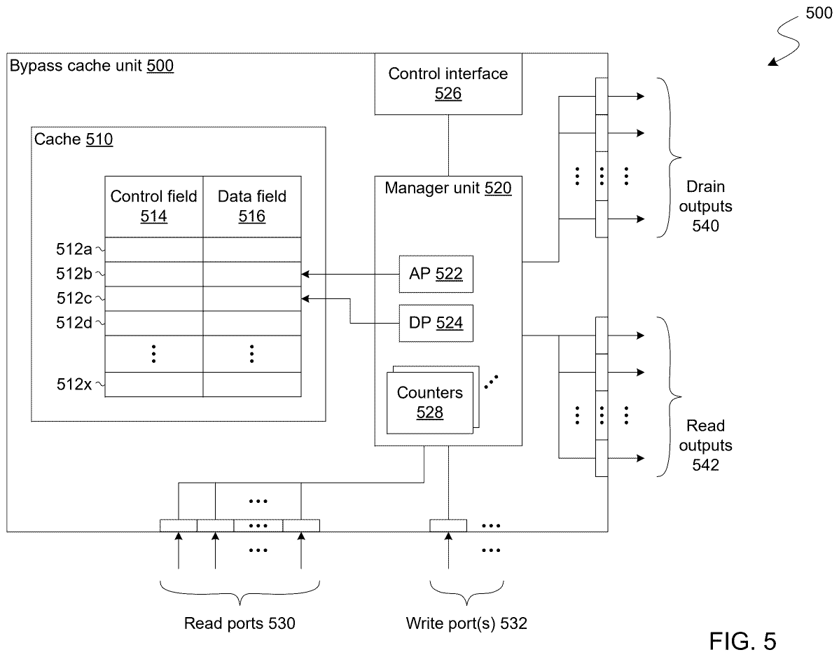

FIG. 5 shows a bypass cache unit 500 which makes operand values available according to an embodiment. Bypass cache unit 500 illustrates features of one example embodiment which caches (e.g., buffers) μop values that are each to be made available for provisioning to a respective execution unit, wherein some or all such μop values are to be drained to a PRF. In some embodiments, bypass cache unit 500 provides functionality such as that of bypass cache unit 152—e.g., wherein operations of method 200 are performed with, or otherwise based on, bypass cache unit 500.

In some embodiments, circuitry of bypass cache unit 500 is adapted from, and/or is incorporated with, any of various suitable processor architectures. By way of illustration and not limitation, any of various suitable embodiments of bypass cache unit 500 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

As shown in FIG. 5, bypass cache unit 500 comprises a cache 510 and a manager unit 520 which is to manage a provisioning of operand values each at a respective one of multiple entries 512 of cache 510. Furthermore, manager unit 520 is to manage the draining of operand values from bypass cache unit 500 to a PRF (not shown) which is to be coupled to bypass cache unit 500.

By way of illustration and not limitation, bypass cache unit 500 facilitates coupling via one or more ports by which operand values are to be provided, over time, each by a respective execution pipeline (not shown) of a processor which comprises bypass cache unit 500. In the example embodiment shown, bypass cache unit 500 is coupled to receive operand values via one or more of the illustrative read ports 530 shown and/or via the illustrative one or more of write ports 532 shown. Furthermore, bypass cache unit 500 comprises at least one output (e.g., illustrated by the drain outputs 540 shown) by which operand values are to be drained to the PRF. Further still, bypass cache unit 500 comprises at least one other output (e.g., illustrated by the read outputs 542 shown) by which operand values are to be read or otherwise communicated to execution pipeline circuitry.

In one such embodiment, cache 510 comprises entries 512a, 512b, 512c, 512d, . . . , 512x which are each available, at various times, to cache, buffer and/or otherwise store a respective operand value received via read ports 530 or write port(s) 532. For example, an allocation pointer (AP) 522 is operated by manager unit 520 to identify a particular one of entries 512 as a next entry to receive an operand value which bypass cache unit 500 receives via any of one or more ports. The storing of an operand value to a given one of entries 512 results in pointer AP 522 being incremented or otherwise updated to point to a next available entry of cache 510.

In some embodiments, the receipt (actual or expected) of an operand value in one of entries 512 causes manager unit 520 to communicate operand location information from a control interface 526 by which bypass cache unit 500 is to be coupled, for example, to tracker unit 120, scheduler unit 130 and/or other suitable circuitry. For example, such operand location information is communicated in a wakeup message to identify the particular one of entries 512a, 512b, 512c, 512d, . . . , 512x which received—or is to receive—the operand value in question.

Furthermore, a drain pointer (DP) 522 is operated by manager unit 520 to identify a particular one of entries 512 as a next entry from which an operand value is to be moved to a PRF (not shown) which is coupled to bypass cache unit 500. The draining of an operand value from a given one of entries 512 results in pointer DP 524 being incremented or otherwise updated to point to a next entry in cache 510 to be drained. In various embodiments, draining of operand values from cache 510 is based on FIFO policy—e.g., wherein entries which include valid operand values are prioritized relative to each other, according to the respective ages of said operand values in cache 510, for the purpose of determining a next operand value to be drained to the PRF.

In the example embodiment shown, entries 512 each comprise a respective data field 516 which is to store a corresponding operand value (or other suitable data). In one such embodiment, entries 512 each further comprise a respective control field 514 which is to store a metadata and/or other information which facilitates a provisioning of the data in the respective field 516 of that entry. For example, the field 514 of a given entry 512 is to store one or more value to specify or otherwise indicate the presence (or absence) of any of various possible conditions regarding data (if any) in the field 516 of that entry 512.

By way of illustration and not limitation, such possible conditions include a condition wherein the entry 512 in question is currently available to be allocated. Another possible condition, for example, is one wherein the entry 512 in question is currently allocated, but yet to have an operand value written to the corresponding field 516 since said allocation. Still another possible condition, for example, is one wherein the entry 512 in question is currently allocated, but a draining or other such dispatching of the entry has since been canceled. The dispatching of an entry is subject to being canceled, for example, by a scheduler unit based on any of various conditions, such as an unavailability of a read port of a PRF. In various embodiments, such possible conditions to be indicated by a control field 514 include one wherein the entry 512 in question was successfully written to, and currently stores valid data in the corresponding field 516. Additionally or alternatively, such possible conditions include one wherein the corresponding field 516 of the entry 512 in question comprises data—even valid data—which has been drained to the PRF.

In some embodiments, the amount of time a given operand value is in cache 510, without being drained to the PRF, is unbounded. In such cases, some embodiments take special consideration to mitigate the risk of an older operand value overwriting a younger operand value in the PRF. By way of illustration and not limitation, manager unit 520 further maintains counters 528 which are each specific to a corresponding one (and, for example, only one) of entries 512. Each such entry-specific counter 528 is to be a basis for a respective evaluation, by manager unit 520, to determine whether a write to a physical register is to be at least temporarily delayed. In one such embodiment, a given counter 528 is initialized, for example, based on the writing of an operand value to the corresponding one of entries 512. At some point during the maintaining of counters 528, manager unit 520 performs an evaluation to determine, based on one such counter 528, whether the corresponding entry 512 has stored a respective operand value for an excessive period of time. For example, the evaluation compares the counter 528 in question to a corresponding threshold count value which, in an embodiment, indicates or otherwise corresponds to a minimum physical destination reuse window. Where the evaluation indicates a violation of such a threshold test condition, manager unit 520 signals—e.g., via the control interface 526—that at least some pre-scheduler functionality is slowed, stalled or otherwise adjusted at least until the potential for an improper write to the PRF is resolved.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors'local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2(L 2 ), level 3(L 3 ), level 4 (L 4), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures-in-order and Out-of-order Core Block Diagram

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register map and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3(L 3 ) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Exemplary Execution Unit(s) Circuitry

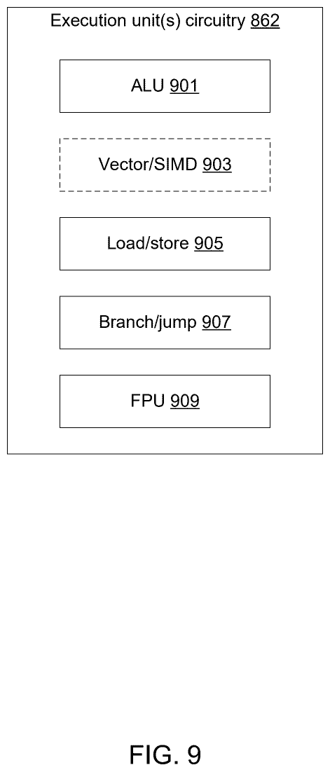

FIG. 9 illustrates examples of execution unit(s) circuitry, such as execution unit(s) circuitry 862 of FIG. 8B. As illustrated, execution unit(s) circuity 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

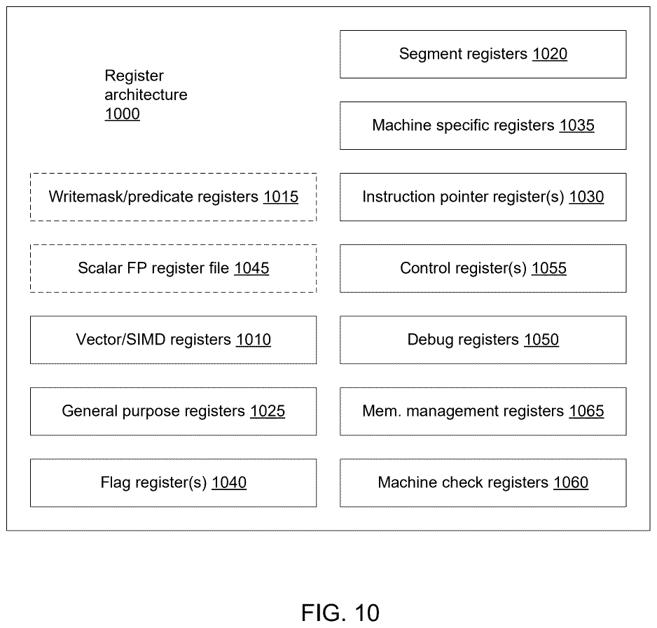

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1000 may, for example, be used in physical register file(s) circuitry 858.

Techniques and architectures for providing an operand of an executable instruction are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor comprises a physical register file (PRF), a writeback path to communicate a value of an operand, a cache which is coupled between the writeback path and the PRF, and a reservation station (RS) coupled to the PRF and the cache, the RS comprising circuitry to receive an indication of a receipt of the value at an entry of the cache, based on the indication, communicate location information which identifies the entry of the cache, determine, based on the location information, a readiness state of a first micro-operation (μop) which comprises the operand, and based on the readiness state, select one of multiple micro-operations (μops) to be allocated for execution, the multiple μops comprising the first μop.

In one or more second embodiments, further to the first embodiment, the RS further comprises circuitry to detect a movement of the value from the cache to the PRF, and based on the movement, update the location information to identify the PRF as a current repository of the value.

In one or more third embodiments, further to the second embodiment, the circuitry to detect the movement of the value from the cache to the PRF comprises circuitry to initialize a counter variable, which corresponds to the operand, based on the indication, update the counter variable based on a rate at which entries of the cache are drained to the PRF, and perform an evaluation to detect for a condition wherein the counter variable satisfies a test condition which is based on a threshold count value corresponding to a maximum expected duration of the value in the cache.

In one or more fourth embodiments, further to the first embodiment or the second embodiment, the receipt of the value of the operand at the entry is a first receipt of a first value of a first operand at a first entry, the first μop further comprises a second operand, the location information is first location information, the RS further comprises circuitry to detect a second receipt of a second value of the second operand at a second entry of the cache, and based on the second receipt, communicate second location information which identifies the second entry of the cache, and the RS is to determine the readiness state of the first μop further based on the second location information.

In one or more fifth embodiments, further to the first embodiment or the second embodiment, determining the readiness state comprises identifying that, for each source operand of the μop, respective location information identifies a respective one of multiple candidate resources as a current repository of a value of the source operand, wherein the multiple candidate resources comprise the cache and the PRF.

In one or more sixth embodiments, further to the fifth embodiment, the multiple candidate resources further comprise a bypass network.

In one or more seventh embodiments, further to the first embodiment or the second embodiment, the RS is to select the one of the multiple μops based on an allocation credit which is to be provided to a scheduler of the processor based on a current occupancy of the cache.

In one or more eighth embodiments, further to the first embodiment or the second embodiment, the entry of the cache comprises a first field to receive the value of the operand, and one or more second fields to provide first metadata to identify a validity of information in the first field.

In one or more ninth embodiments, further to the eighth embodiment, the one or more second fields are further to provide second metadata to identify whether the entry is currently allocated.

In one or more tenth embodiments, a method at a processor, the method comprises receiving an indication of a receipt of a value of an operand at an entry of a cache which is coupled between a writeback path and a physical register file (PRF), based on the indication, communicating in a reservation station of processor the location information which identifies the entry of the cache, based on the location information, determining at the reservation station a readiness state of a first micro-operation (μop) which comprises the operand, and based on the readiness state, selecting one of multiple micro-operations (μops) to be allocated for execution, the multiple μops comprising the first μop.

In one or more eleventh embodiments, further to the tenth embodiment, the method further comprises communicating the value of the operand to the entry of the cache via the writeback path.

In one or more twelfth embodiments, further to the tenth embodiment or the eleventh embodiment, the method further comprises detecting a movement of the value from the cache to the PRF, and based on the movement, updating the location information at the reservation station to identify the PRF as a current repository of the value.

In one or more thirteenth embodiments, further to the twelfth embodiment, detecting the movement of the value from the cache to the PRF comprises initializing a counter variable, which corresponds to the operand, based on the indication, updating the counter variable based on a rate at which entries of the cache are drained to the PRF, and performing an evaluation to detect for a condition wherein the counter variable satisfies a test condition which is based on a threshold count value corresponding to a maximum expected duration of the value in the cache.

In one or more fourteenth embodiments, further to the tenth embodiment or the eleventh embodiment, the receipt of the value of the operand at the entry is a first receipt of a first value of a first operand at a first entry, the first μop further comprises a second operand, the location information is first location information, the method further comprises detecting a second receipt of a second value of the second operand at a second entry of the cache, and based on the second receipt, communicating in the reservation station second location information which identifies the second entry of the cache, and determining the readiness state of the first μop is further based on the second location information.

In one or more fifteenth embodiments, further to the tenth embodiment or the eleventh embodiment, determining the readiness state comprises identifying that, for each source operand of the μop, respective location information identifies a respective one of multiple candidate resources as a current repository of a value of the source operand, wherein the multiple candidate resources comprise the cache and the PRF.

In one or more sixteenth embodiments, further to the fifteenth embodiment, the multiple candidate resources further comprise a bypass network.

In one or more seventeenth embodiments, further to the tenth embodiment or the eleventh embodiment, selecting the one of the multiple μops is based on a provisioning of an allocation credit to a scheduler of the processor, wherein the provisioning is based on a current occupancy of the cache.

In one or more eighteenth embodiments, further to the tenth embodiment or the eleventh embodiment, the entry of the cache comprises a first field to receive the value of the operand, and one or more second fields to provide first metadata to identify a validity of information in the first field.

In one or more nineteenth embodiments, further to the eighteenth embodiment, the one or more second fields are further to provide second metadata to identify whether the entry is currently allocated.

In one or more twentieth embodiments, a system comprises a memory to store data, a memory controller, a processor coupled to the memory via the memory controller, the processor comprising a physical register file (PRF), a writeback path to communicate a value of an operand, a cache which is coupled between the writeback path and the PRF, and a reservation station (RS) coupled to the PRF and the cache, the RS comprising circuitry to receive an indication of a receipt of the value at an entry of the cache, based on the indication, communicate location information which identifies the entry of the cache, determine, based on the location information, a readiness state of a first micro-operation (μop) which comprises the operand, and based on the readiness state, select one of multiple micro-operations (μops) to be allocated for execution, the multiple μops comprising the first μop.

In one or more twenty-first embodiments, further to the twentieth embodiment, the RS further comprises circuitry to detect a movement of the value from the cache to the PRF, and based on the movement, update the location information to identify the PRF as a current repository of the value.

In one or more twenty-second embodiments, further to the twenty-first embodiment, the circuitry to detect the movement of the value from the cache to the PRF comprises circuitry to initialize a counter variable, which corresponds to the operand, based on the indication, update the counter variable based on a rate at which entries of the cache are drained to the PRF, and perform an evaluation to detect for a condition wherein the counter variable satisfies a test condition which is based on a threshold count value corresponding to a maximum expected duration of the value in the cache.

In one or more twenty-third embodiments, further to the twentieth embodiment or the twenty-first embodiment, the receipt of the value of the operand at the entry is a first receipt of a first value of a first operand at a first entry, the first μop further comprises a second operand, the location information is first location information, the RS further comprises circuitry to detect a second receipt of a second value of the second operand at a second entry of the cache, and based on the second receipt, communicate second location information which identifies the second entry of the cache, and the RS is to determine the readiness state of the first μop further based on the second location information.

In one or more twenty-fourth embodiments, further to the twentieth embodiment or the twenty-first embodiment, determining the readiness state comprises identifying that, for each source operand of the μop, respective location information identifies a respective one of multiple candidate resources as a current repository of a value of the source operand, wherein the multiple candidate resources comprise the cache and the PRF.

In one or more twenty-fifth embodiments, further to the twenty-fourth embodiment, the multiple candidate resources further comprise a bypass network.

In one or more twenty-sixth embodiments, further to the twentieth embodiment or the twenty-first embodiment, the RS is to select the one of the multiple μops based on an allocation credit which is to be provided to a scheduler of the processor based on a current occupancy of the cache.

In one or more twenty-seventh embodiments, further to the twentieth embodiment or the twenty-first embodiment, the entry of the cache comprises a first field to receive the value of the operand, and one or more second fields to provide first metadata to identify a validity of information in the first field.

In one or more twenty-eighth embodiments, further to the twenty-seventh embodiment, the one or more second fields are further to provide second metadata to identify whether the entry is currently allocated.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
a physical register file (PRF);
a writeback path to communicate a value of an operand;
a cache which is coupled between the writeback path and the PRF; and
a reservation station (RS) coupled to the PRF and the cache, the RS comprising circuitry to:
receive an indication of a receipt of the value at an entry of the cache;
based on the indication, communicate location information which identifies the entry of the cache;
determine, based on the location information, a readiness state of a first micro-operation (μop) which comprises the operand; and
based on the readiness state, select one of multiple micro-operations (μops) to be allocated for execution, the multiple μops comprising the first μop.

2. The processor of claim 1, wherein the RS further comprises circuitry to:
detect a movement of the value from the cache to the PRF; and
based on the movement, update the location information to identify the PRF as a current repository of the value.

3. The processor of claim 2, wherein the circuitry to detect the movement of the value from the cache to the PRF comprises circuitry to:
initialize a counter variable, which corresponds to the operand, based on the indication;
update the counter variable based on a rate at which entries of the cache are drained to the PRF; and
perform an evaluation to detect for a condition wherein the counter variable satisfies a test condition which is based on a threshold count value corresponding to a maximum expected duration of the value in the cache.

4. The processor of claim 1, wherein:
the receipt of the value of the operand at the entry is a first receipt of a first value of a first operand at a first entry;
the first μop further comprises a second operand;
the location information is first location information;
the RS further comprises circuitry to:
detect a second receipt of a second value of the second operand at a second entry of the cache; and
based on the second receipt, communicate second location information which identifies the second entry of the cache; and
the RS is to determine the readiness state of the first μop further based on the second location information.

5. The processor of claim 1, wherein determining the readiness state comprises identifying that, for each source operand of the μop, respective location information identifies a respective one of multiple candidate resources as a current repository of a value of the source operand, wherein the multiple candidate resources comprise the cache and the PRF.

6. The processor of claim 5, wherein the multiple candidate resources further comprise a bypass network.

7. The processor of claim 1, wherein the RS is to select the one of the multiple μops based on an allocation credit which is to be provided to a scheduler of the processor based on a current occupancy of the cache.

8. The processor of claim 1, wherein the entry of the cache comprises:
a first field to receive the value of the operand; and
one or more second fields to provide first metadata to identify a validity of information in the first field.

9. The processor of claim 8, wherein the one or more second fields are further to provide second metadata to identify whether the entry is currently allocated.

10. A method at a processor, the method comprising:
receiving an indication of a receipt of a value of an operand at an entry of a cache which is coupled between a writeback path and a physical register file (PRF);
based on the indication, communicating in a reservation station of processor the location information which identifies the entry of the cache;
based on the location information, determining at the reservation station a readiness state of a first micro-operation (μop) which comprises the operand; and
based on the readiness state, selecting one of multiple micro-operations (μops) to be allocated for execution, the multiple μops comprising the first μop.

11. The method of claim 10, further comprising:
communicating the value of the operand to the entry of the cache via the writeback path.

12. The method of claim 10, further comprising:
detecting a movement of the value from the cache to the PRF; and
based on the movement, updating the location information at the reservation station to identify the PRF as a current repository of the value.

13. The method of claim 12, wherein detecting the movement of the value from the cache to the PRF comprises:
initializing a counter variable, which corresponds to the operand, based on the indication;
updating the counter variable based on a rate at which entries of the cache are drained to the PRF; and
performing an evaluation to detect for a condition wherein the counter variable satisfies a test condition which is based on a threshold count value corresponding to a maximum expected duration of the value in the cache.

14. The method of claim 10, wherein determining the readiness state comprises identifying that, for each source operand of the μop, respective location information identifies a respective one of multiple candidate resources as a current repository of a value of the source operand, wherein the multiple candidate resources comprise the cache and the PRF.

15. The method of claim 10, wherein selecting the one of the multiple μops is based on a provisioning of an allocation credit to a scheduler of the processor, wherein the provisioning is based on a current occupancy of the cache.

16. A system comprising:
a memory to store data;
a memory controller;
a processor coupled to the memory via the memory controller, the processor comprising:
a physical register file (PRF);
a writeback path to communicate a value of an operand;
a cache which is coupled between the writeback path and the PRF; and
a reservation station (RS) coupled to the PRF and the cache, the RS comprising circuitry to:
receive an indication of a receipt of the value at an entry of the cache;
based on the indication, communicate location information which identifies the entry of the cache;
determine, based on the location information, a readiness state of a first micro-operation (μop) which comprises the operand; and
based on the readiness state, select one of multiple micro-operations (μops) to be allocated for execution, the multiple μops comprising the first μop.

17. The system of claim 16, wherein the RS further comprises circuitry to:
detect a movement of the value from the cache to the PRF; and
based on the movement, update the location information to identify the PRF as a current repository of the value.

18. The system of claim 17, wherein the circuitry to detect the movement of the value from the cache to the PRF comprises circuitry to:
initialize a counter variable, which corresponds to the operand, based on the indication;
update the counter variable based on a rate at which entries of the cache are drained to the PRF; and
perform an evaluation to detect for a condition wherein the counter variable satisfies a test condition which is based on a threshold count value corresponding to a maximum expected duration of the value in the cache.

19. The system of claim 16, wherein determining the readiness state comprises identifying that, for each source operand of the μop, respective location information identifies a respective one of multiple candidate resources as a current repository of a value of the source operand, wherein the multiple candidate resources comprise the cache and the PRF.

20. The system of claim 16, wherein the RS is to select the one of the multiple μops based on an allocation credit which is to be provided to a scheduler of the processor based on a current occupancy of the cache.
